(19) United States
(12) Patent Application Publication
(10) Pub. No.: US 2017/0142917 A1
(43) Pub. Date: May 25, 2017

(54) Precipitation Sensor Controller for Automatic Sprinkler Systems

(71) Applicant: Bassam Maaz, Bloomfield, MI (US)

(72) Inventor: Bassam Maaz, Bloomfield, MI (US)

(21) Appl. No.: 14/950,409

(22) Filed: Nov. 24, 2015

(51) Int. Cl. A01G 25/16; G01W 1/14; B05B 12/12

(52) U.S. Cl. CPC A01G 25/16; B05B 12/12; G01W 1/14

(57) ABSTRACT

A precipitation sensor control for automatic sprinkler systems assesses precipitation in the atmosphere in order to prevent the use of excess water. The precipitation sensor control includes a translucent prism, at least one light generation source, at least one photo-sensor, and a sprinkler system actuator. A light emission from the at least one light generation source. The at least one light generation source is in optical communication with the at least one photo-sensor where the light emission is directed across and through a first base surface of the translucent prism then reflects through the translucent prism. The light emission is reflected into the at least one photo-sensor. As precipitation collects onto the first base surface, the light emission is obscured from the at least one photo-sensor. When the light emission is obscured, the sprinkler system actuator deactivates the automatic sprinkler system, preventing a waste for drinking water.

### FIELD OF THE INVENTION

The present invention relates generally to a precipitation sensor controller. More specifically, the present invention relates to a precipitation sensor controller which assesses precipitation local to an automatic sprinkler system in order to control the automatic sprinkler system schedule. During times of precipitation, the present invention prevents the use of excess water from automatic sprinkler systems.

### BACKGROUND OF THE INVENTION

Automatic sprinklers are used in order to keep a healthy lawn and garden in areas where precipitation is erratic or in a drought. In general, automatic sprinklers systems are programmed to shower lawns and gardens with water at specified times. The logic of these automatic sprinkler systems check the time and do not assess any weather conditions. Therefore, when raining over the sprinkler system overlaps a time which the sprinkler system is set to go off, the lawn and garden will be showered from both the natural weather conditions and the automatic sprinkler system. As automatic sprinkler systems are generally piped into a drinkable water source, the disposal of drinkable water onto lawns and gardens while the weather is raining or recently rained is considered a waste of drinking water.

Therefore, it is an object of the present invention to provide a sensing mechanism in order to prevent the use of an automatic sprinkler system during precipitating weather. The present invention makes use of light optics in order to assess if precipitation is occurring, as the precipitation, water, snow, ice, etc., obscures or refracts light away from a light sensor. Once the optical connection is broken though the refraction of light, the present invention deactivates the automatic sprinkler system, preventing the use of excess water.

### BRIEF DESCRIPTION OF THE DRAWINGS

FIG. 1 is a perspective view of the present invention.

FIG. 2 is a side view of the present invention.

FIG. 3 is a side view of the translucent prism detailing a path for the light emission from the light generation source to the at least one photo-sensor.

FIG. 4 is a side view of the translucent prism detailing the path for the light emission where the light emission is refracted away from the at least one photo-sensor.

FIG. 5 is perspective view of the present invention normal to the ground spike.

FIG. 6 is a schematic view for electrical components of the present invention for embodiments including a toggle switch.

FIG. 7 is a schematic view for the electrical components of the present invention for embodiments including a transmitter.

FIG. 8 is a schematic view for the electrical components of the present invention for embodiments including an impact sensor.

### DETAIL DESCRIPTIONS OF THE INVENTION

All illustrations of the drawings are for the purpose of describing selected versions of the present invention and are not intended to limit the scope of the present invention.

The present invention is a precipitation sensor controller for automatic sprinkler systems. The present invention assesses whether the instantaneous weather is precipitating in order to manipulate the automatic sprinkler system by signaling or shutting down the automatic sprinkler system when the local weather is precipitating. Deactivating or interrupting the automatic sprinkler system during precipitation prevents excessive water usage.

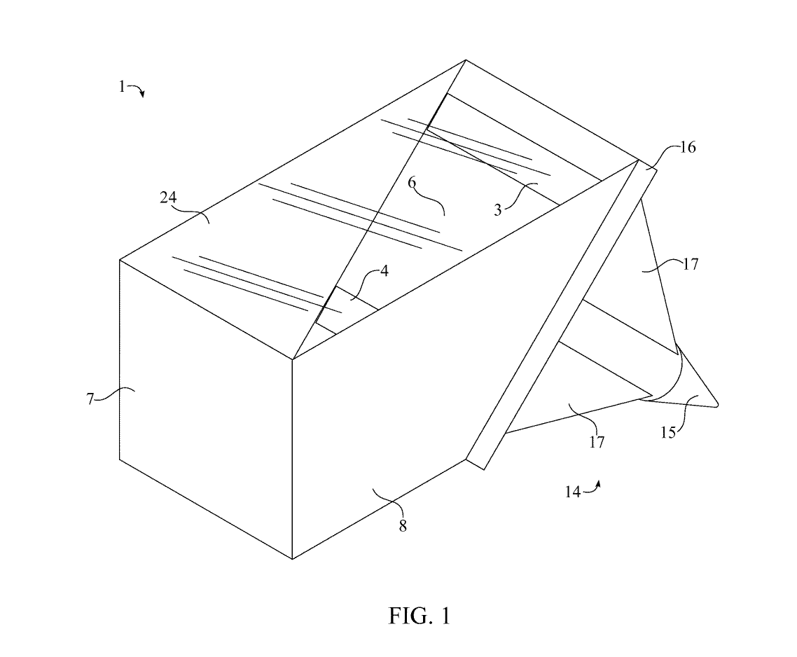

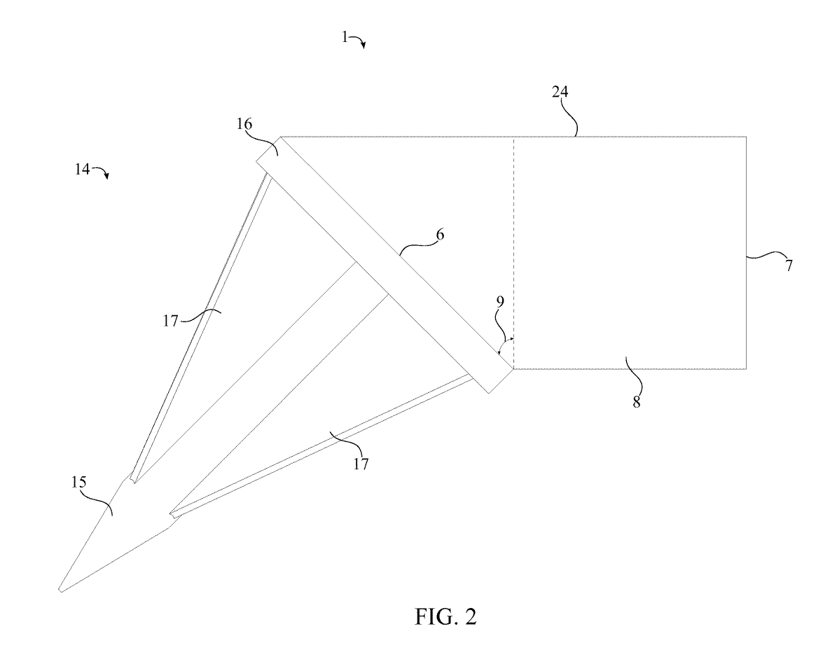

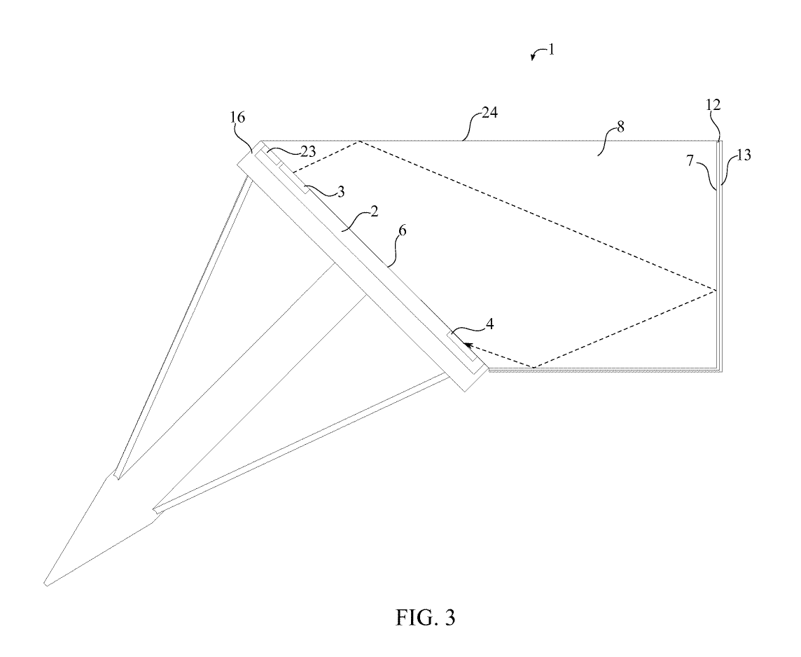

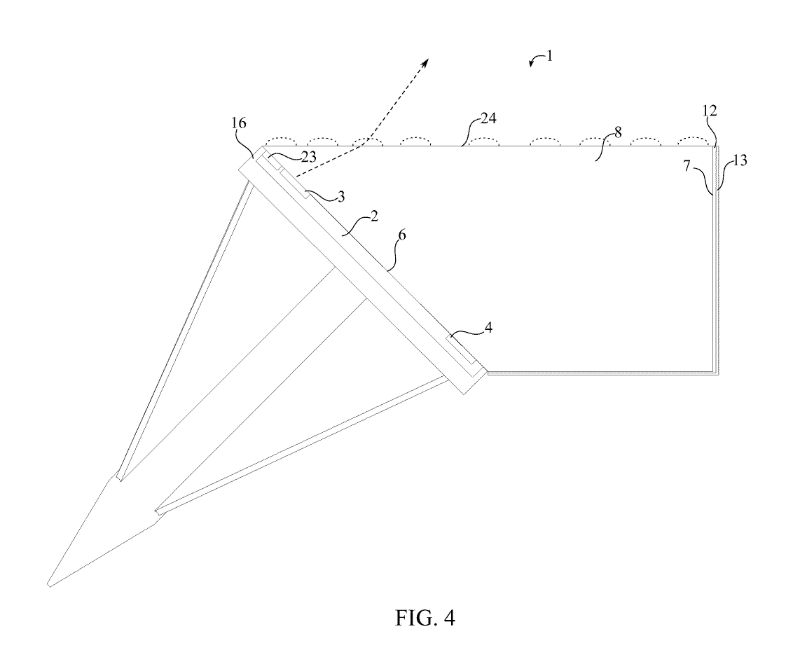

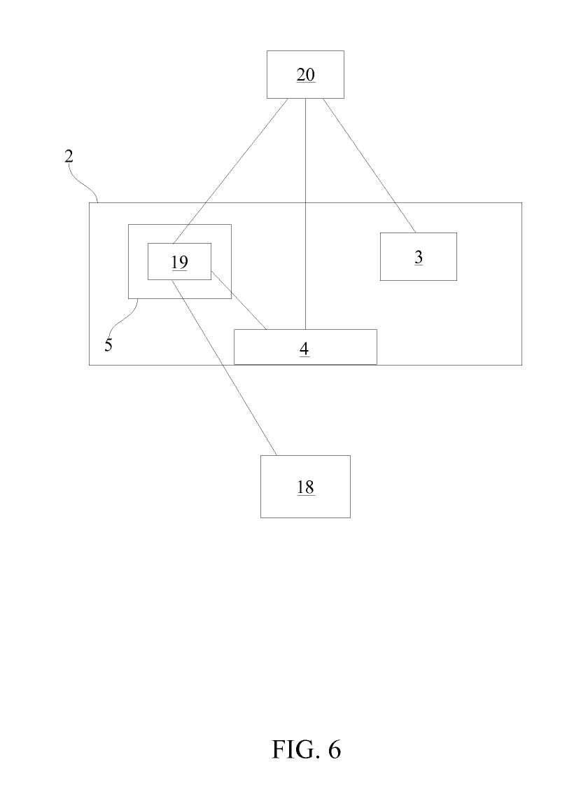

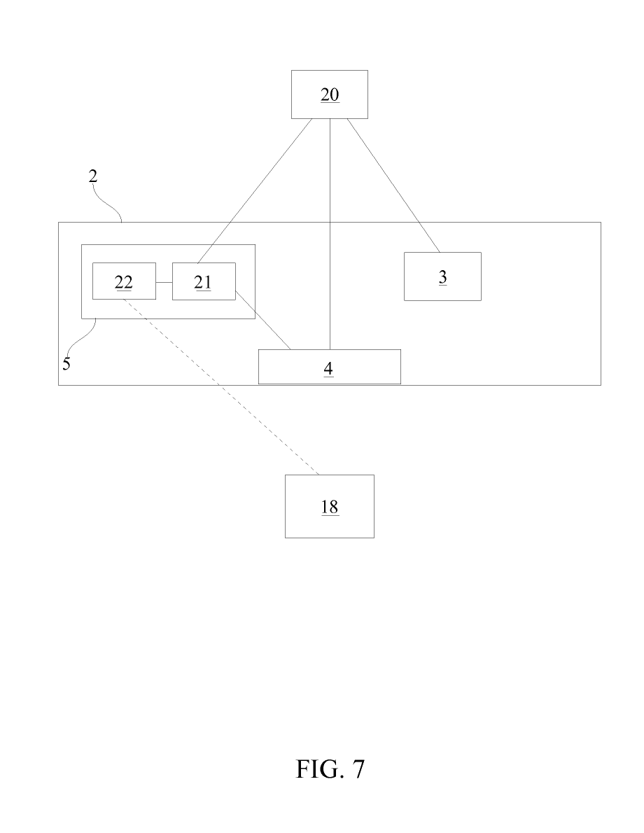

The present invention comprises a translucent prism 1, a component housing 2, at least one light generation source 3, at least one photo-sensor 4, and a sprinkler system actuator 5. The translucent prism 1 provides a refractory structure for an emission of light to traverse through. In accordance to FIG. 1, the translucent prism 1 comprises a first base surface 6, a second base surface 7 and a lateral surface 8. The first base surface 6 is an angled surface which a light emission enters the translucent prism 1. The second base surface 7 provides a surface which the light emission to be reflected within the translucent prism 1. The lateral surface 8 comprises an exposed surface 24. The exposed surface 24 is positioned parallel with the ground in order for precipitation to collect onto the exposed surface 24. The first base surface 6 and the second base surface 7 are oriented at an acute angle 9 to each other, as shown in FIG. 2. The acute angle 9 is preferred to be a forty-five degree angle in order to provide proper optical alignment for the at least one light generation source 3. The component housing 2 protects the electrical components of the present invention including the at least one light generation source 3, the at least one photo-sensor 4, and the sprinkler system actuator 5, as detailed in FIG. 6 and FIG. 7. The component housing 2 is mounted onto the first base surface 6, adjacent to the lateral surface 8, as shown in FIG. 3 and FIG. 4. The at least one light generation source 3 emits a light emission to be received by the at least one photo-sensor 4, where the light emission is an input control signal. The at least one light generation source 3 is integrated into the component housing 2, adjacent lateral surface 8, as shown in FIG. 3 and FIG. 4. The light generation source 3 is oriented towards an interior 11 of the translucent prism 1 and positioned opposite to the at least one photo-sensor 4 within the component housing 2. The at least one photo-sensor 4 assesses whether the light emission is obscured by precipitation and signals the sprinkler system actuator 5 to manipulate an automatic sprinkler system 18. The at least one photo-sensor 4 is integrated into the component housing 2, adjacent to the first base surface 6, in accordance to FIG. 3 and FIG. 4. The sprinkler system actuator 5 is mounted within the component housing 2, as shown in FIG. 6 and FIG. 7. The at least one photo-sensor 4 is electronically connected to the sprinkler system actuator 5 such that an output from the at least one photo-sensor 4 determines the logic for the sprinkler system actuator 5. For example, if the light emission is obscured from precipitation, the sprinkler system actuator 5 prevents the automatic sprinkler system 18 from dispensing water.

In accordance to the preferred embodiment and FIG. 3 and FIG. 4, present invention comprises a reflective film 12. The reflective film 12 allows the light emission to be reflected through the translucent prism 1 such that the at least one light generation source 3 is in optical communication with the at least one photo-sensor 4. The reflective film 12 is superimposed onto the second base surface 7 and the lateral surface 8 while leaving the exposed surface 24 unobscured. The light emission is generated by the at least one light generation source 3 and traverses into the translucent prism 1 towards the exposed surface 24. In accordance to FIG. 3, when there is not any precipitation or other obstruction collected on the exposed surface 24, the light emission totally internally reflects off of the exposed surface 24 towards the second base surface 7. The light emission is angled toward the exposed surface 24 such that an angle of incident of the light emission is an angle greater than the critical angle of incidence for the medium interface. The critical angle of incidence is the angle from the normal to an incident surface which light is totally internally reflected within a translucent medium due to the refractive indices of the mediums which make up a refractive interface. The light emission then reflects off of the reflective film 12 adjacent to the second base surface 7, traverses back through the translucent prism 1, and is received by the at least one photo-sensor 4. In accordance to FIG. 4, when precipitation collects onto the exposed surface 24, the light emission is refracted away from the translucent prism 1 by the precipitation collected on top of the exposed surface 24. In some embodiments, the present invention comprises an opaque coating 13. The opaque coating 13 is superimposed onto the reflective film 12. The opaque coating 13 prevents interference from extraneous light sources which cause false indications and outputs from the at least one photo-sensor 4.

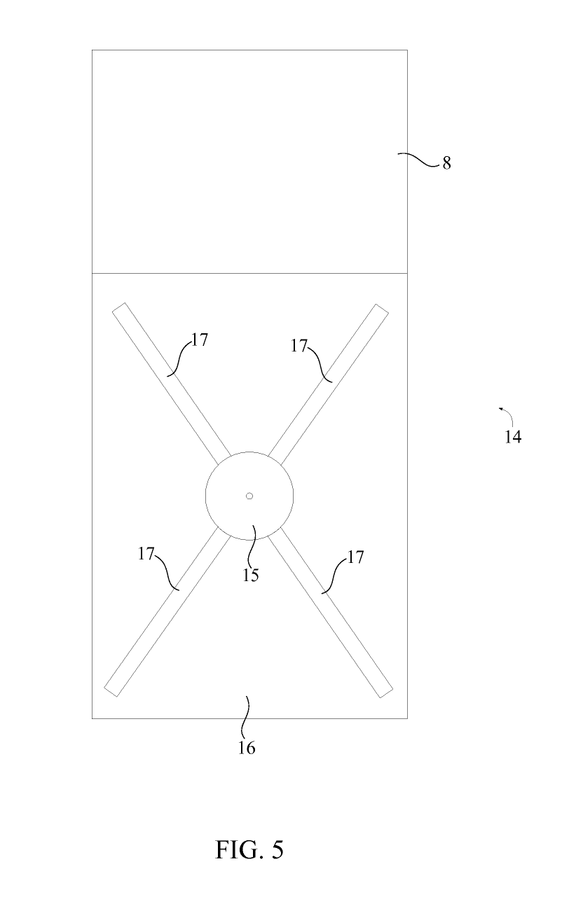

Further in accordance to the preferred embodiment, FIG. 1 to FIG. 5, the present invention comprises a ground mount 14. The ground mount 14 secures the present invention into the ground by extending into the ground for support. The ground mount 14 comprises a yard spike 15 and an end cap 16. They yard spike 15 is inserted into the ground while the end cap 16 secures the ground mount 14 to the translucent prism 1. As shown in FIG. 3 and FIG. 4, the end cap 16 is mounted to onto the lateral surface 8 about the component housing 2. The yard spike 15 is centrally mounted to the end cap 16, as shown in FIG. 5, opposite to component housing 2, shown in FIG. 2. As the present invention is mounted into the ground, the yard spike 15 is inserted into the ground at a forty five degree angle such that the exposed surface 24 is parallel to the ground surface and precipitation is able to collect onto the exposed surface 24 in order to assess local precipitation.

In some embodiments, the present invention comprises a plurality of yard spike fins 17, as shown in FIG. 1, FIG. 2, and FIG. 5. The plurality of yard spike fins 17 is extrusions which provide additional support for the present invention to the ground. The plurality of yard spike fins 17 is laterally connected around the yard spike 15. The plurality of yard spike fins 17 is adjacently connected to the end cap 16. The plurality of yard spike fins 17 is evenly distributed about the yard spike 15. This configuration allows for the plurality of yard spike fins 17 to have sufficient support on the yard spike 15 and the end cap 16, as well as providing the present invention with a resistance to rotation when the present invention is mounted into the ground.

In accordance to the preferred embodiment, the present invention comprises a power source 20, detailed in FIG. 6 to FIG. 8. The power source 20 provides electrical power to the electrical component. The at least one light generation source 3, the at least one photo-sensor 4 and the sprinkler system actuator 5 are electrically connected to the power source 20 in order to draw power to produce the light emission, to assess the light emission orientation, and to translate and transmit the assessment to the automatic sprinkler system 18. The power source 20 is preferred to be integrated into a residential electric circuit; however, the power source 20 may also include, but is not limited to, solar power and batteries.

As previously mentioned, the sprinkler system actuator 5 deactivates the automatic sprinkler system 18. Due to a plurality of automatic sprinkler systems existing in the market, the present invention comprises several embodiments allowing the present invention to interface with the automated sprinkler system 18. In some embodiments, the sprinkler system actuator 5 comprises a toggle switch 19, in accordance to FIG. 6. The toggle switch 19 selectively allows electricity to be provided to the automatic sprinkler system 18. The at least one photo-sensor 4 is electronically connected to the toggle switch 19 such that the output from at least one photo-sensor determines the position of the toggle switch 19. The toggle switch 19 is electrically connected to the power source 20. The toggle switch 19 is electrically connected to the automatic sprinkler system 18 to allow or prevent a flow of electricity. In some other embodiments, the sprinkler system actuator 5 is electronically connected to the automatic sprinkler system 18, such that the output from the at least one photo-sensor 4 is translated into a control input signal by the sprinkler system actuator 5 to manipulate the automatic sprinkler system 18 according to weather conditions.

In yet other embodiments of the present invention, the sprinkler system actuator 5 comprises a microcontroller 21 and a transmitter 22, in accordance to FIG. 7. The microcontroller 21 translates the output signal from the at least one photo-sensor 4 into a control input signal for the automatic sprinkler system 18. The transmitter 22 facilitates the communication for the control input signal to the automatic sprinkler system 18. The at least one photo-sensor 4 is electronically connected to the microcontroller 21 in order to receive the output signal from the at least one photo-sensor 4. The microcontroller 21 is electronically connected to the transmitter 22, which allows the microcontroller 21 to be communicatively coupled to the automatic sprinkler system 18 through the transmitter 22 such that the control input signal is transmitted wirelessly to the automatic sprinkler system 18 through the use of radio frequency, Bluetooth, or similar means.

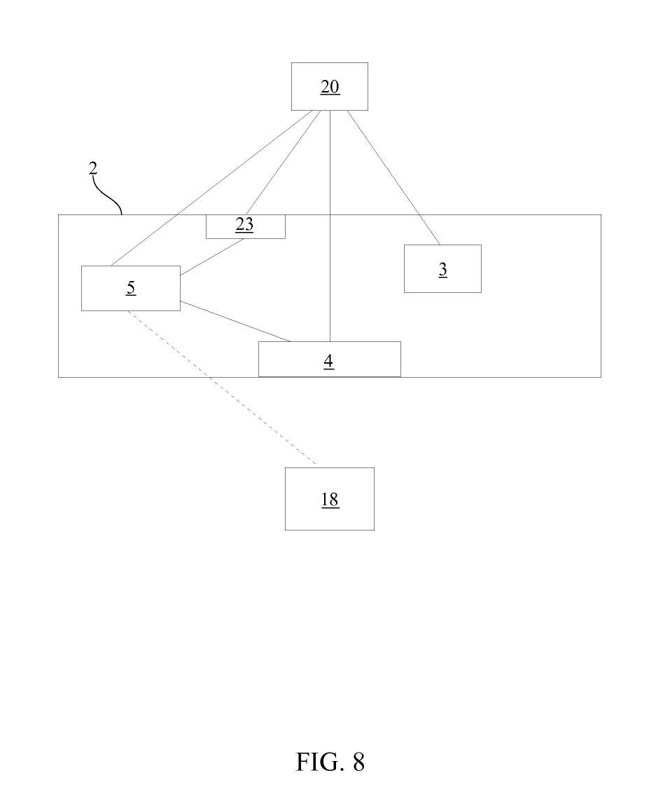

In some embodiments of the present invention, the present invention comprises an impact sensor 23, as shown in FIG. 3 and FIG. 8. The impact sensor 23 provides redundant means for assessing precipitation. The impact sensor 23 is internally mounted within the component housing 2, such that the component housing 2 protects the impact sensor 23 from the elements. In accordance to FIG. 3, the impact sensor 23 is positioned adjacent to the exposed surface 24 such that the impact from the precipitation is not dampened through the component housing 2. The impact sensor 23 is electronically connected to the sprinkler system actuator 5, detailed in FIG. 8. As precipitation falls, the energy from the velocity change as the falling precipitation contacts exposed surface 24 registers an input signal for the impact sensor 23. Based on the frequency of input signals, the impact sensor 23 assesses significant precipitation as the frequency of input signals rise above a pre-set threshold. Once the frequency of input signals rises above the pre-set threshold, the impact sensor 23 outputs to the sprinkler system actuator 5. The sprinkler system actuator 5 receives the output from the impact sensor 23 to translate the output from the impact sensor 23 into a control output signal to manipulate the automatic sprinkler system 18.

Although the invention has been explained in relation to its preferred embodiment, it is to be understood that many other possible modifications and variations can be made without departing from the spirit and scope of the invention as hereinafter claimed.

What is claimed is:

1. A precipitation sensor controller for automatic sprinkler systems comprises:
a translucent prism;
a component housing;
at least one light generation source;
at least one photo-sensor;
a sprinkler system actuator;
the translucent prism comprises a first base surface, a second base surface, and a lateral surface;
the lateral surface comprising an exposed surface;
the first base surface and second base surface being oriented at an acute angle to each other;
the component housing being mounted onto the first base surface, adjacent to the lateral surface;
the light generation source being integrated into the component housing, adjacent to the lateral surface;
the light generation source being oriented towards an interior of the translucent prism;
the photo-sensor being integrated into the component housing, adjacent to the first base surface;
the photo-sensor being electronically connected to the sprinkler system actuator; and
the sprinkler system actuator being mounted within component housing.

2. The precipitation sensor controller for automatic sprinkler systems, as claimed in claim 1, comprises:
an impact sensor;
the impact sensor being internally mounted within the component housing;
the impact sensor being positioned adjacent to the exposed surface;
the impact sensor being electronically connected to the sprinkler system actuator;

3. The precipitation sensor controller for automatic sprinkler systems, as claimed in claim 1, comprises:
a reflective film; and
the reflective film being superimposed onto the lateral surface and the second base surface.

4. The precipitation sensor controller for automatic sprinkler systems, as claimed in claim 4, comprises:
the at least one light generation source being in optical communication with the at least one photo-sensor through the translucent prism, wherein a light emission is generated by the at least one light generation source, traverses into the translucent prism towards the exposed surface, reflects towards the second base surface, reflects off the reflective film adjacent to the second base surface, traverses back through the translucent prism, and is received by the at least one photo-sensor.

5. The precipitation sensor controller for automatic sprinkler systems, as claimed in claim 4, comprises:
an opaque coating; and
the opaque coating being superimposed onto the reflective film.

6. The precipitation sensor controller for automatic sprinkler systems, as claimed in claim 1, comprises:
a ground mount;
the ground mount comprises a yard spike and an end cap;
the end cap being mounted onto the lateral, about the component housing; and
the yard spike being centrally mounted to the end cap, opposite the component housing.

7. The precipitation sensor controller for automatic sprinkler systems, as claimed in claim 7, comprises:
a plurality of yard spike fins;
the plurality of yard spike fins being laterally connected around the yard spike;
the plurality of yard spike fins being adjacently connected to the end cap; and
the plurality of yard spike fins being evenly distributed about the yard spike.

8. The precipitation sensor controller for automatic sprinkler systems, as claimed in claim 1, comprises:
an automatic sprinkler system;
the sprinkler system actuator comprises a toggle switch;
the at least one photo-sensor being electronically connected to the toggle switch; and
the toggle switch being electrically connected to the automatic sprinkler system. 19

9. The precipitation sensor controller for automatic sprinkler systems, as claimed in claim 9, comprises:
a power source; and
the toggle switch being electrically connected to the power source.

10. The precipitation sensor controller for automatic sprinkler systems, as claimed in claim 1, comprises:
an automatic sprinkler system;
the sprinkler system actuator comprises a microcontroller and a transmitter;
the at least one photo-sensor being electronically connected to the microcontroller;
the microcontroller being electronically connected to the transmitter; and
the microcontroller being communicatively coupled to the automatic sprinkler system through the transmitter.

11. The precipitation sensor controller for automatic sprinkler systems, as claimed in claim 1, comprises:
a power source; and
the at least one light generation source, the at least one photo-sensor and the sprinkler system actuator being electrically connected to the power source.

12. The precipitation sensor controller for automatic sprinkler systems, as claimed in claim 12, comprises:
an impact sensor;
the impact sensor being electrically connected to the power source;
